(19) United States
(12) Patent Application Publication
(10) Pub. No.: US 2015/0183377 A1
(43) Pub. Date: Jul. 2, 2015

(54) STORAGE CHAMBER ASSEMBLY IN A MACHINE

(71) Applicant: Caterpillar Inc., Peoria, IL (US)

(72) Inventors: THOMAS S. RUFFNER, Washington, IL (US); Kurt L. Winckler, Washington, IL (US)

(73) Assignee: Caterpillar Inc., Peoria, IL (US)

(21) Appl. No.: 14/656,747

(22) Filed: Mar. 13, 2015

(51) Int. Cl. B60R 7/04

(52) U.S. Cl. CPC B60R 7/04

(57) ABSTRACT

A chamber assembly disposed in an operator cab of a machine is disclosed. The chamber assembly includes a base member and a plurality of side walls for defining a cavity therebetween. The base member includes one or more first holes to drain fluid contained in the cavity. One of the plurality of side walls includes one or more openings to fluidly communicate the cavity with an air conditioning system of the machine. The chamber assembly further includes a lining member detachably disposed on the base member. The lining member includes one or more second holes to allow the fluid to flow therethough and communicate with the first holes of the base member. The lining member further includes one or more projections to abut the base member. The lining member further includes a receptacle member to hold one or more vessels.

### TECHNICAL FIELD

The present disclosure relates to a chamber assembly for storing objects at a controlled temperature in a machine.

### BACKGROUND

In an operator cab of a machine, beverages and food items are generally kept for consumption by an operator or any other person. These beverages are typically stored in one or more vessels. The vessels may be kept in a dashboard, between a driver seat and a co-driver seat or inside the pockets provided in the side doors of the machine. The beverages and food items, such as, hot tea, coffee or chocolate, iced tea, burgers or fries, may be consumed either hot or cold. When these food items and beverages are exposed to ambient temperature, they may loose their original temperature. Further, there may be accumulation of fluid within the operator cab due to spillage and condensation process. Spillage of the beverages may occur if the vessels are not in upright position and/or the machine experiences a jerk. Additionally, the leftover food items may cause dirtiness within the operator cab.

U.S. Pat. No. 5,713,546 (the '546 patent) relates to a foldable holder for beverage containers and other items having a generally horizontal tray provided with a hole for accommodating a beverage container. A U-shaped member pivotally mounted to the tray traverses the bottom of the hole to provide a support for the beverage container and retain the container within the hole of the tray. The tray is supported above the ground with a stake pivotally connected to one end of the tray. The stake can be pivoted into a side-by-side relationship relative to the tray to facilitate the carrying and storage of the holder. The U-shaped member is also pivoted in a generally folded position relative to the tray, so the entire tray is located in a generally common plane. However, the tray disclosed in the '546 patent may not be used for storing the beverages and/or the food items at a controlled temperature to maintain original temperature thereof.

### SUMMARY OF THE DISCLOSURE

In one aspect of the present disclosure, a chamber assembly disposed in an operator cab of a machine is provided. The chamber assembly is configured to store one or more objects. The chamber assembly includes a base member and a plurality of side walls extending from the base member. The base member and the plurality of side walls are structured and arranged to define a cavity therebetween. The base member includes one or more first holes that are configured to drain fluid contained in the cavity of the chamber assembly. At least one of the plurality of side walls includes one or more openings that are configured to fluidly communicate the cavity of the chamber assembly with an air conditioning system of the machine. The chamber assembly further includes a lining member that is configured to be received within the cavity of the chamber assembly and detachably disposed on the base member. The lining member includes a top surface and a bottom surface distal to the top surface. The bottom surface is overlaid on the base member. The lining member further includes one or more second holes extending between the top surface and the bottom surface. The one or more second holes are configured to communicate with the one or more first holes of the base member. The lining member further includes one or more projections extending from the bottom surface thereof. The one or more projections are configured to abut the base member to define a space between the base member and the bottom surface of the lining member to allow the fluid to flow therethrough. The lining member further includes a receptacle member defined on the top surface of the lining member. The receptacle member is configured to hold one or more vessels. The chamber assembly also includes a cover member configured to enclose the cavity defined by the plurality of side walls and the base member.

Other features and aspects of this disclosure will be apparent from the following description and the accompanying drawings.

### BRIEF DESCRIPTION OF THE DRAWINGS

FIG. 1 is a partial perspective view of a chamber assembly containing a lining member with a receptacle member, according to an embodiment of the present disclosure;

FIG. 2 is an exploded view showing the lining member and the chamber assembly of FIG. 1; and

FIG. 3 is a sectional view of the chamber assembly taken along section line A-A′ in FIG. 1.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

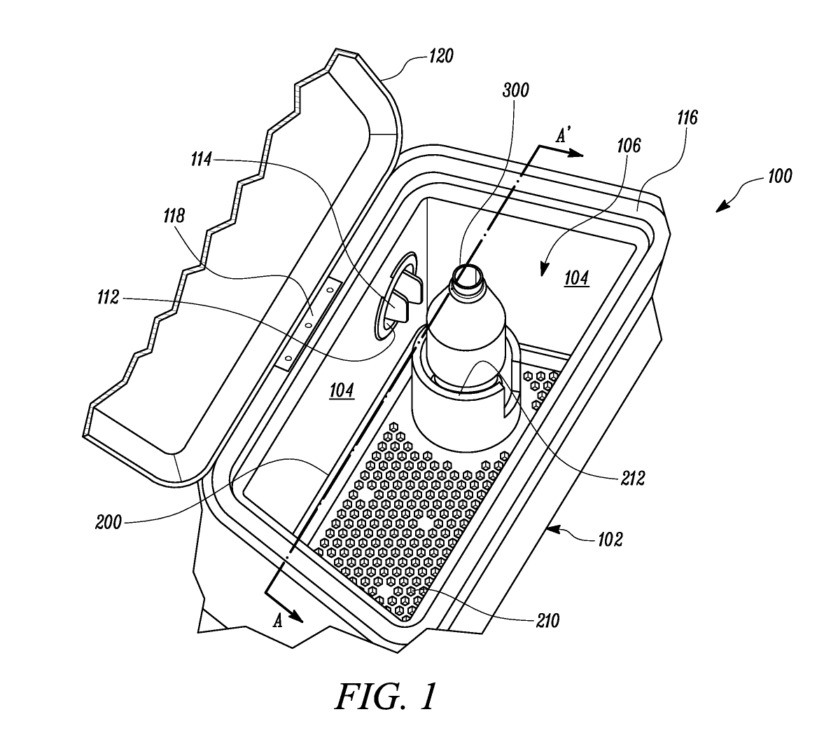

FIG. 1 illustrates a perspective view of a chamber assembly 100 disposed in an operator cab (not shown) of a machine (not shown). The chamber assembly 100 may be used for storing food items, beverages, medicines and the like at various temperatures. The temperature within the chamber assembly 100 may be varied depending on a temperature set interior of the operator cab. The temperature at interior of the operator cab may be set via an air-condition system of the machine. In various examples, the chamber assembly 100 may be disposed adjacent to a dash board, between a driver seat and a co-driver seat or inside the pockets provided in the side doors of the machine. The chamber assembly 100 includes a base member 102 and a plurality of side walls 104 extending from the base member 102. The base member 102 and the plurality of side walls 104 are structured and arranged to define a cavity 106 therebetween. In the illustrated embodiment, the chamber assembly 100 includes four side walls 104 integrally formed with the base member 102. It may be contemplated that the base member 102 and the plurality of side walls 104 may be individual members connected each other to define the cavity 106. The food items, beverages, medicines and the like may be accommodated within the cavity 106. The chamber assembly 100 further includes one or more openings 112 defined at one of the side walls 104. The one or more openings 112 are configured to fluidly communicate the cavity 106 of the chamber assembly 100 with the air conditioning system (not shown) of the machine. In the illustrated embodiment, one opening 112 is defined in one of the side walls 104. The opening 112 may be fluidly communicated to the air conditioning system (not shown) via one or more fluid lines (not shown). The air conditioning system of the machine may be controlled by an operator to supply conditioned air at a desired temperature within the operator cab. The conditioned air may also communicate with the chamber assembly 100 through the fluid lines and the opening 112. The openings 112 may be selectively opened or closed by a lid 114 depending on a need to cool or warm the objects. The lid 114 may be movable between an open position and a closed position. In FIG. 1, the lid 114 is kept in the open position. The lid 114 may be moved between the open position and the closed position by the operator to allow a controlled supply of the conditioned air within the chamber assembly 100. In an example, the lid 114 may be a flap.

The chamber assembly 100 further includes a cover member 120. The cover member 120 is configured to enclose the cavity 106 defined by the side walls 104 and the base member 102 of the chamber assembly 100. In the illustrated embodiment, the cover member 120 may be pivotally coupled to an upper edge 116 of one of the side walls 104 via one or more hinge members 118. In other embodiments, the cover member 120 may be detachably engaged with the upper edges 116 of the side walls 104. The chamber assembly 100 further includes a lining member 200. The lining member 200 is structured and arranged to be received within the cavity 106 of the chamber assembly 100 and detachably disposed on the base member 102. The lining member 200 will be described in detail herein below.

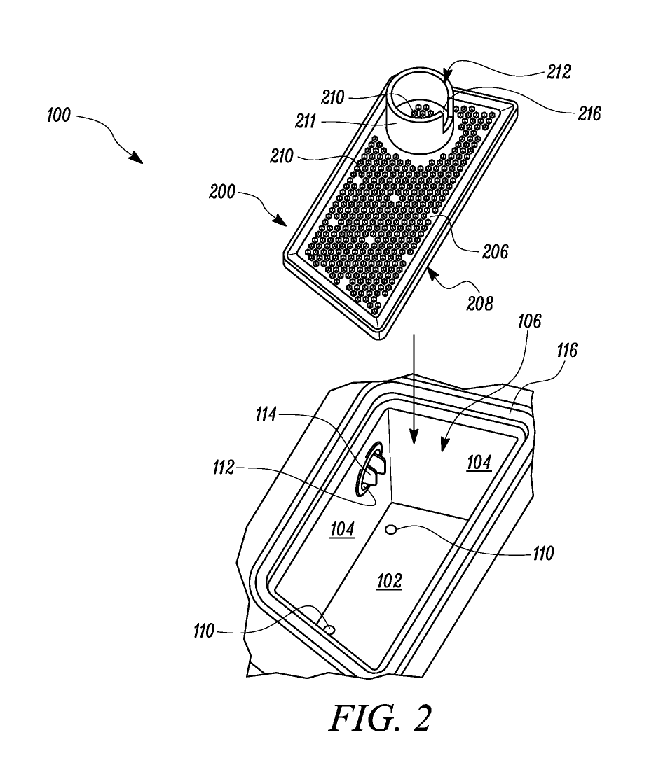

Referring to FIG. 2, the base member 102 includes one or more first holes 110. The first holes 110 are configured to drain a fluid contained in the cavity 106 of the chamber assembly 100. The fluid in the cavity 106 may be formed due to condensation process within the cavity 106. The first holes 110 may also be used for draining any particulate matter contained in the cavity 106 along with the fluid. In the illustrated embodiment, the base member 102 includes two first holes 110. In another embodiment, a cap member (not shown) may be used for closing the first holes 110.

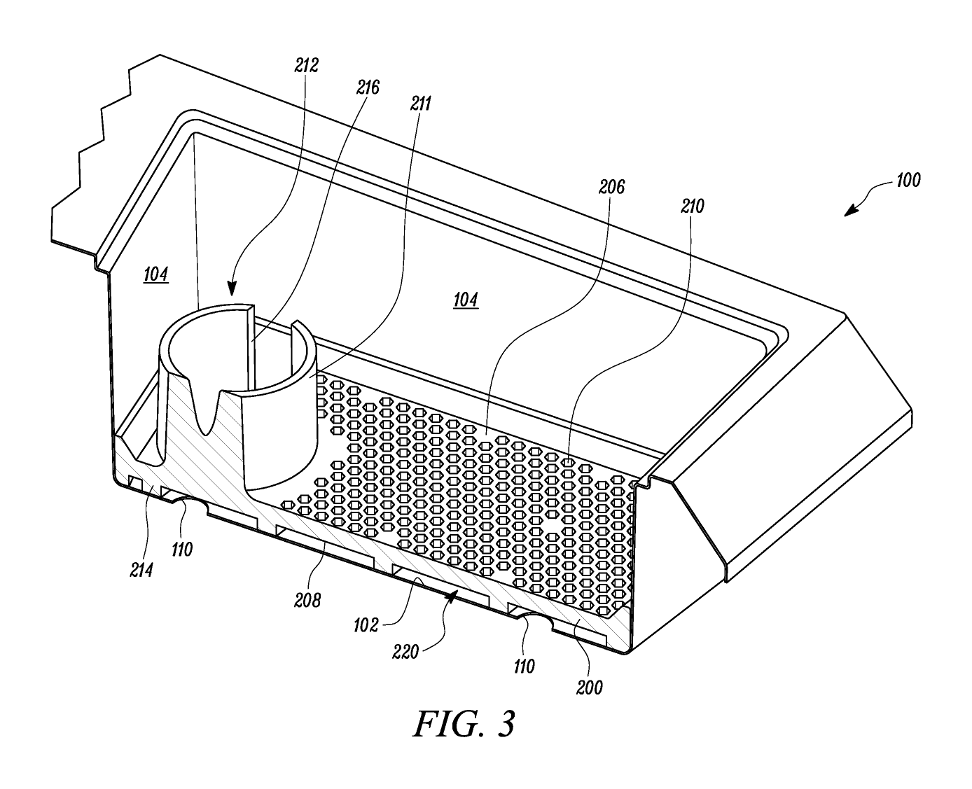

Referring to FIGS. 2 and 3, the lining member 200 includes a top surface 206 and a bottom surface 208 distal to the top surface 206. The bottom surface 208 is overlaid on the base member 102. The lining member 200 further includes one or more second holes 210. The second holes 210 extend between the top surface 206 and the bottom surface 208 of the lining member 200. The second holes 210 are structured to communicate with the first holes 110 of the base member 102. In the illustrated embodiment, the second holes 210 may have a hexagonal cross section. However, the cross section of the second holes 210 may be a square, a circular or any other shape known in the art.

The lining member 200 may define an outer periphery less than or equal to an inner periphery defined by the side walls 104 of the chamber assembly 100 adjacent to the base member 102. Further, the lining member 200 may be made from elastic materials, such as rubber or any polymer known in the art. Hence, the lining member 200 is resiliently and detachably disposed on the base member 102 of the chamber assembly 100.

The lining member 200 further includes a receptacle member 212. The receptacle member 212 is defined on the top surface 206 of the lining member 200. The receptacle member 212 is configured to hold one or more vessels 300 (shown in FIG. 1). The receptacle member 212 includes a protrusion 211 extending from the top surface 206 of the lining member 200. The protrusion 211 may be integrally formed with the lining member 200. In the illustrated embodiment, the receptacle is in a circular shape to hold the vessel 300. In an example, the vessel 300 may be a bottle. However, the receptacle member 212 may have a square, or any other shape known in the art. The receptacle member 212 may further include a slot 216 defined in the protrusion 211. The slot 216 may allow the receptacle member 212 to hold the vessels 300, such as a cup having laterally extending handle. The receptacle member 212 may also be laterally stretched to hold vessels having various sizes that may be accommodated within a permissible elastic limit of the protrusion 211 of the receptacle member 212 the permissible elastic limit may vary depending on type of material of the protrusion 211. The receptacle member 212 may also be used as a gripping member for the operator to remove the lining member 200 from the chamber assembly 100. Referring to FIG. 3, the lining member 200 further includes one or more projections 214 extending from the bottom surface 208. The projections 214 are configured to abut the base member 102 of the chamber assembly 100. Further, a space 220 is defined between the base member 102 and the bottom surface 208 of the lining member 200. The space 220 may allow the fluid to flow therethrough, such that the fluid coming through the second holes 210 of the lining member 200 is drained through the first holes 110 of the base member 102.

### INDUSTRIAL APPLICABILITY

The present disclosure relates to the chamber assembly 100 for storing objects at the controlled temperature. The temperature in the cavity 106 of the chamber assembly 100 is controlled based on the temperature maintained interior of the operator cab. The lid 114 is used for controlling the flow of the conditioned air to the cavity 106 such that the temperature within the chamber assembly 100 may be further controlled. The lining member 200 and the receptacle 212 are very flexible to handle as the lining member 200 and the receptacle member 212 are made from elastic materials. The receptacle member 212 may facilitate holding and retaining of the vessels 300 in the upright position during operation of the machine, such that, spilling of water or any liquid contained in the vessels 300 may be avoided. The receptacle member 212 is also used as the gripping member for removing the lining member 200 from the chamber assembly 100 such that no additional member is provided in the lining member 200. The second holes 210 are also provided within the receptacle member 212 such that the fluid formed within the receptacle member 212 may also pass through the second holes 210 and drained through the first holes 110. The first and the second holes 210 may drain the fluid formed due to the condensation process within the cavity 106. The first holes 110 may also facilitate cleaning of the chamber assembly 100. During cleaning, the lining member 200 may be removed from the chamber assembly 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A chamber assembly disposed in an operator cab of a machine, the chamber assembly configured to store one or more objects, the chamber assembly comprising:
a base member and a plurality of side walls extending from the base member, the base member and the plurality of side walls structured and arranged to define a cavity therebetween, wherein the base member comprises one or more first holes configured to drain fluid contained in the cavity of the chamber assembly, wherein at least one of the plurality of side walls comprises one or more openings, the openings configured to fluidly communicate the cavity of the chamber assembly with an air conditioning system of the machine;
a lining member configured to be received within the cavity of the chamber assembly and detachably disposed on the base member, the lining member comprising:
a top surface and a bottom surface distal to the top surface, the bottom surface overlaid on the base member;
one or more second holes extending between the top surface and the bottom surface, the one or more second holes configured to communicate with the one or more first holes of the base member;
one or more projections extending from the bottom surface, the one or more projections configured to abut the base member to define a space between the base member and the bottom surface of the lining member to allow the fluid to flow therethrough;
a receptacle member defined on the top surface of the lining member, the receptacle member configured to hold one or more vessels; and
a cover member configured to enclose the cavity defined by the plurality of side walls and the base member.
